(19) United States
(12) Patent Application Publication
(10) Pub. No.: US 2004/0043203 A1
(43) Pub. Date: Mar. 4, 2004

(54) Laminated visual optical effects plastic product and process for preparation

(76) Inventor: George Bogdanovic, Downers Grove, IL (US)

Correspondence Address: Leon I. Edelson, Levenfeld Pearlstein, PO Box 0212, Chicago, IL, 60690-0212, US

(21) Appl. No.: 10/651,818

(22) Filed: Aug. 29, 2003

Related U.S. Application Data
(60) Provisional application No. 60/407,721, filed on Sep. 3, 2002.

(51) Int. Cl. B32B 3/00

(52) U.S. Cl. 428/201

(57) ABSTRACT

The invention relates to a laminated multi-layer visual optical effects structure plastic product which can be a card or similar object and to the process for producing the plastic product structure with printed visual optical effects structure layers comprising a printed linear aperture clear and opaque sections on one surface of a clear plastic substrate and another layer of printed interlaced images on the opposing surface of the clear plastic substrate, either the same clear plastic substrate or multiples thereof. Printing can be by offset lithography or by silk-screen printing. Positioning and alignment of the printed images is controlled by a computer graphics program.

This application claims the benefit of Provisional Patent Application No. 60/407,721 filed on Sep. 3, 2002.

### FIELD OF INVENTION

The present invention relates to a unique visual optical effects structure multi-layer plastic product which can be a credit card, an identification card or other personal object subject to repeated wear and tear wherein the plastic multi-layer product can be hydraulically laminated under heat and pressure to obtain a very strong, durable, rigid product to withstand heavy personal use and provides special visual optical effects including but not limited to 3-D images, motion images, morphing images and changeable images without use of a formed lens. The plastic multi-layer product can also be adhesively laminated. The present invention relates to the unique plastic multi-layer laminated product and to the process for producing the unique plastic product with a visual effects structure comprising linear aperture clear space and printed opaque sections on one side and interlaced images on the opposite side to provide special visual effects.

The present invention accordingly also relates to a visual optical effects structure product and to a process for producing a laminated multi-layered optical effects linear aperture product having a core of clear material made up of one or multiple clear plastic materials printed on opposing plastic material surfaces to create optical effects structure comprising linear aperture clear spaces and printed opaque sections on one side and interlaced image(s) on the opposing side by using offset lithography, silk-screen, or other methods of producing fine quality reproduction thus creating a durable, laminated, protected, ultra flat card product that provides special visual optical effects including but not limited to 3-D images, motion images, morphing images and changeable images without the use of a formed lens.

The use of pre-cast lenticular lens material or using movable shutters used to provide the special visual effects described above is well known, but hydraulic lamination of pre-cast plastic lenticular lens can cause distortion or total loss of the lens. Using an optical interference structure of linear aperture clear spaces and printed opaque sections on one surface and interlaced images on the opposing surface to create a special visual optical structural effects product to obviate the use of a precast plastic lenticular lens and then converting the product to a solid cohesive, durable, protected, lay-flat product in a wide range of thickness by lamination is unique. Typical applications are debit/credit cards, ID cards, loyalty cards and all ANSI (American National Standard) spec cards in general. Other applications also include point-of-purchase displays, clipboards, rulers, calculators, baggage tags, mouse pads, and similar articles.

### BACKGROUND OF THE INVENTION

The card industry in their search for new and creative cards has been searching for a product that can withstand the use/abuse of consumers. The current ANSI spec card can do this. When a special effects lenticular lens card as described above has been manufactured on pre-cast lens material it has not held up with hard usage to ANSI specs. The card also requires the lens to be overall and not in isolated areas. While stagnant copy could be used, the lens still interferes with the stagnant image. The present invention allows the optical interference linear aperture clear spaces with printed opaque sections to be in any designated area or overall. If there is stagnant copy, there is no optical interference.

In the prior art, a number of patents discuss the manufacture of laminate identification cards having visual images, plastic lenticular surfaces and similar structures.

Manufacture of identification cards with holograms is discussed in U.S. Pat. No. 2002/0018253 to Toshine, and 4,999,075 to Coburn. Cards having a lenticular surface and a printed image on an opposite surface are discussed in U.S. Pat. No. 5,753,344 to Jacobsen, and 6,073,854 to Bravenec. U.S. Pat. No. 5,695,346 to Sekiguchi discusses a display of viewing images generated with a computer on a viewable surface wherein the viewing member comprises a lenticular lens of several types, preferably anamorphic lens. The use of laser beams to prepare an identification card is discussed in U.S. Pat. No. 4,894,110 to Lass and 4,544,181 to Maurer. Laminated identification cards are discussed in U.S. Pat. No. 3,949,501 to Andrews, 3,654,022 to Wiest and EP 1189079 to Gacho and WO 01/53113 to Phillips. Phillips '113 teaches use of an optical diffraction pattern as a security element for credit cards. A plastic card wherein graphical elements are printed on different surfaces with different backgrounds having different levels of opacity is discussed in WO 02/45008 to Rotondo.

Although elements of the process of the invention are taught in the prior art, i.e., lithographic printing on plastic film, and the use of an optical interference pattern, the process of placing an optical effects structure formation layer comprising printed linear aperture clear space and opaque sections on one surface of a clear material and another layer of interlaced images on the opposing surface of the clear material, hydraulically or adhesively laminating the two surfaces into a fully protected unit has not been disclosed in the prior art. Additional elements of the process of the invention relating to the specific required procedure and materials utilized differentiate the process and product of the invention from processes and products taught in the prior art. The additional elements of the optical effects structure include producing printed indicia by offset lithographic printing, positioning the printed indicia to be in alignment with each other, aligning the linear aperture clear space and printed opaque sections to the interlaced images on opposing surfaces by use of a computer graphics program, positioning the printed interlaced images adjacent to each other as portions of different graphic images by use of a computer graphics program, the use of totally clear laminated sheet to cause the printed linear aperture images to become viewable after processing the multiple sheets to a one-piece see-through object by a hydraulic laminating press under heat and pressure or adhesively laminating the multiple sheets to provide an ultra-flat product that creates special visual effects.

### SUMMARY OF INVENTION

The invention relates to a laminated multi-layer visual optical effects structure plastic product which can be a card or similar object and to the process for producing the structure plastic product with a printed visual optical effects formation layer comprising printed linear aperture clear space and printed opaque sections on one surface of a clear plastic sheet and another layer of interlaced images on the opposing surface of a clear plastic sheet, either the same clear plastic sheet or multiple sheets thereof. The optical effects formation layer of printed aperture clear spaces and opaque sections is positioned in alignment with the interlaced images by use of a computer graphics program to provide visual effects. The plastic product can be hydraulically-laminated under heat and pressure to laminate the plastic sheet and/or sheets into a fully protected unit as a very strong and durable rigid product. The visual optical effects and images are protected from scratching and wear, bending and flexibility, are impervious to moisture, have lay-flatness and longevity. Adhesive lamination can be substituted for hydraulic lamination although adhesive lamination may not be equally satisfactory as hydraulic lamination for long term use and may not convert matte surfaces to clear surfaces.

### BRIEF DESCRIPTION OF THE DRAWINGS

FIG. 1 is a schematic cross sectional view of a multi-layer structure product of this invention showing the printed optical effects formation linear aperture layer 12 on one surface of a clear plastic sheet 11, the printed optical effects formation linear aperture layer 12 consisting of printed multiple aperture clear space and opaque sections 30, printed interlaced images layer 14, the printed interlaced images layer 14 consisting of alternating interlaced separator framed images 31, each of 1/1000 of an inch, A, B, C, D, E, F, G, H. The number of interlaced separator framed images can vary from two up to the limit of the printing process and multiples thereof, to about 1000 separator framed images per 1/75 of an inch, and of lesser and greater sets, as shown in FIGS. 2, 3, and 4, wherein an over-laminate film 10 and an over-laminate film 20 are laminated over the printed optical effects linear aperture clear space and printed opaque sections layer 12 and the printed interlaced separator framed images layer 14 wherein the individual images are separated by interlaced separators which are in alignment with linear aperture clear and opaque sections. The linear aperture clear space and opaque sections serve as alignment marks on the surface of layer 11. FIG. 1 also illustrates viewing of eight separator framed interlaced images A-H wherein the thickness of the film layer 11 and alignment of separator framed images A-H with apertures of layer 12 permit viewing of separate images as by a formed lens. The printed apertures of 12 can vary per inch. The printed interlaced images of 14 repeat interlaced images 31 based on printed apertures of 12. The alternating images of 31 can range from two to being repeated and limited in number only by the production process.

FIG. 2 is a cross-sectional view of one multi-layer product of this invention wherein an overlaminate clear plastic film 10 is laminated over a printed optical effects linear aperture clear space and opaque sections on layer 12 consisting of printed multiple linear aperture clear and opaque sections 30 on one side of clear plastic film 11, the printed interlaced separator framed images layer 14 consisting of alternating interlaced separator framed image frames 31 of separator framed images A, B, AB, and multiples thereof, and printed interlaced separator framed images layer 14 on the other opposing side of clear plastics film 11 and over-laminate clear plastic film 20 is laminated over printed interlaced separator framed images layer 14.

FIG. 3 is a cross-sectional view of a multi-layer product of this invention wherein a multi-layered plastic object of greater thickness with clear over-laminate plastic on two exterior sides is prepared by application of suitably-sized clear plastic sheet 18 and plastic sheet 19 of at least equal and greater thickness to said printed optical effects layer pattern of linear aperture clear and opaque sections layer 12 consisting of printed multiple linear aperture space and opaque sections 30 on one side of clear plastic film 11 and to said other side of clear plastic film 11 printed with interlaced separator framed images layer 14 consisting of alternating interlaced separator framed images 31 of A, B, and multiples thereof wherein an over-laminate clear plastic film 10 is laminated over said clear plastic sheet 18 and an over-laminate clear plastic film 20 is laminated over clear plastic sheet 19.

FIG. 4 is a cross-sectional view of a multi-layer product of this invention of greater thickness comprising two layers of plastic film 11 and 22 to be merged together, the outside layer of first film 11 printed with printed optical effects layer pattern consisting of printed multiple linear clear and opaque sections 30 of linear aperture clear and opaque sections layer 12 over which is laminated over-laminate clear plastic film 10, the outside layer of second film 22 printed with interlaced frame image and separators layer 14, consisting of alternating frame images and separator frames 31 of A, B and multiples thereof, and over-laminate 20 is laminated over printed interlaced frame image and separators layer 14.

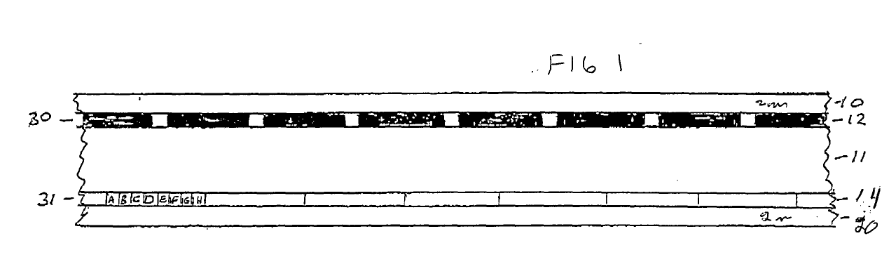

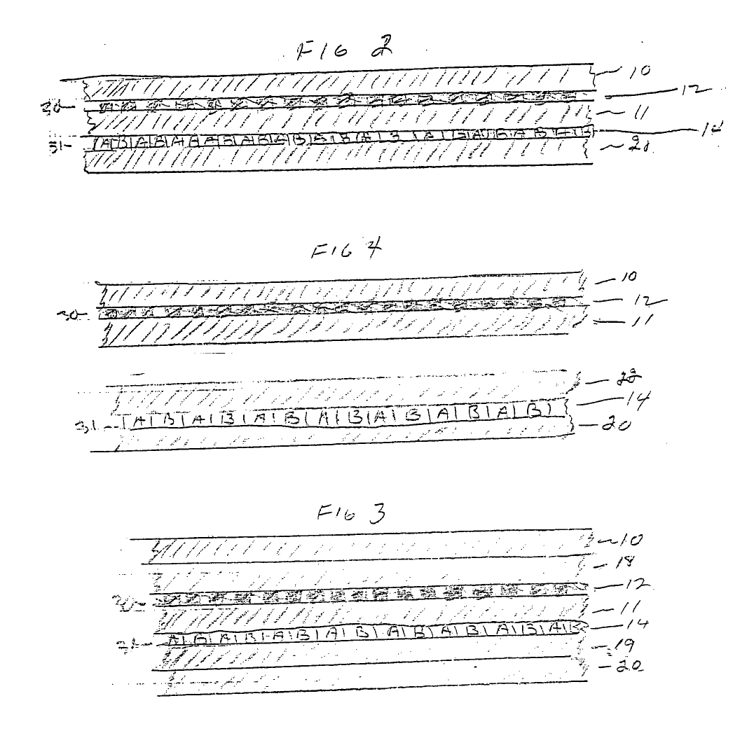

### DETAILS OF THE INVENTION

The invention relates to a laminated multi-layer visual optical effects structure for a plastics product wherein the product has as a first element, an optical effects formation layer on one surface of a plastic sheet and an interlaced images layer on the opposing opposite surface of the plastic sheet or on an opposing surface of multiple plastic sheets as a second element of the visual optical effects structure. The interlaced images typically are separator framed when needed for the application of the optical effects plastic product.

The invention also relates to the process for making a multi-layered visual optical effects structure and layer formation comprising a first element of a linear aperture clear and opaque sections layer with another layer of interfaced separate framed images as a second element on opposing surfaces as a laminate wherein alignment of the linear aperture clear and opaque sections layer to the interlaced separator framed images, and positioning thereof is by a computer graphics program, to provide a durable, laminated, protected, ultra-flat product that can be used to obtain special visual effects including but not limited to 3-D images, motion images, morphing images or a sequence of image motions, and changeable images without use of a formed lens.

The invention accordingly relates to a hydraulically laminated or adhesively laminated multi-layer visual optical effects structure plastic product on clear or a combination of clear and opaque plastic materials with an optical interference linear aperture clear space and opaque section layer separated from another layer of interlaced separator framed images by clear material space to obtain special visual effects and which is converted into a single, cohesive, durable product by a lamination process. The opaque sections of the aperture layer serve as alignment marks.

According to the present invention, a clear or matte clear plastic up to a 40 mil thickness is imaged with separator framed images on opposing sides with an optical effects formation layer comprising a linear aperture clear and opaque sections layer on one surface with or without stagnant images, the opposing side layer then being imaged with interlaced separator framed images directly in register with the optical effects layer and any stagnant copy. White or translucent opacity can be added in any area on either side on top of or beneath the interlaced separator framed images to add special effects such as windows or gradations of density. An alternative is to use the same imaging methods as above but to print on one side of two sheets of material instead of one sheet and merge them in register prior to the lamination process. Clear protective overlay material of varying thickness with pre-application of magnetic stripes, foil, or the like can be added to the top only, bottom only or both sides of the final product. The final multi-layered unit is then hydraulically laminated using heat and pressure to form a cohesive unit. After cooling, the product can be processed by a variety of finishing methods including foil applications, holographic applications, signature panels, additional imaging, card punching, hollow-die die-cutting, steel-rule die-cutting, guillotine cutting, vacuum forming, and the like. The final multi-layered unit can be adhesively laminated to form a cohesive unit. As an alternative, if adhesive lamination is substituted for hydraulic lamination the resulting product may be subject to separation of the laminates when stressed by pressure or exposed to heat as in a closed car exposed to sunlight. The adhesive lamination may not convert matte surface plastic to clear surfaces as well as obtained by hydraulic lamination.

The product can be debit/credit cards, ID cards, and other types of cards, point of purchase displays, clip boards, and similar objects. If the product is a card or personal object subject to wear and tear, the object is covered on both sides with a transparent plastic material that is bonded to the object by thermal or adhesive means depending on the characteristics of the materials used. These materials include polyvinylchloride, polyvinylacetate, polyvinylalcohol, polyesters, polyethylenes polystyrene, polyethylene terephthalate (PET), polyethylene terephtalate glycol (PETG), amorphous polyethylene terephtalate (A-PET) and other plastic materials including any suitable resin-based polymer. In summary, the application is for visual optically variable graphics in a retail environment wherein three dimensional images, motion images, morphing images, flip images and other depth images can be prepared and are available as visual images.

The instant invention relates to a method of manufacture to allow simple and inexpensive production of an ANSI (American National Standard) spec card with visual optically variable graphics. The visual optical effects linear operative graphics structure consists of two components: an optical effects layer pattern of linear aperture of a clear and opaque section structure layer and a flat printed image layer of interlaced images within separator frames. The formation of the linear aperture clear space and opaque sections layer is of printed aperture clear space and opaque sections of interlaced images within separator frames focusing the eyesight of the viewer on different parts of the underlying image layer. The printed interlaced image layer is made of multiple interlaced images within separator frames printed in interlaced transition images in alignment with said printed aperture space, and alignment marks. A band of each image is printed sequentially with bands of each additional image.

If three images are to be combined, then the composite image layer print includes a band of image one, a band of image two, then a band of image three. The printing pattern is repeated for the entire composite print. When viewed through the printed optical effects layer pattern of the optical effects layer screen, a different view of the image is received from different angles. A special visual effect is created. The optical effects layer of the linear apertures pattern is described in terms of sections per inch. The composite image layer is printed to match the linear apertures pattern and alignment. Optimum viewing distances for large format graphs is three feet to infinity.

The formation of the linear aperture and opaque sections layer is in accordance with the interlaced images layer, as determined by a computer as to the evaluation of the viewing elements required by the graphics program, to form the visual optical effects structure of the plastic multi-layer product.

The viewing elements of the visual optical effects structure of the plastic multi-layer product which comprises two elements, the optical effects layer pattern and the interlaced images layer, include the anticipated viewing distance, the physical size of the multi-layer product, the optical effect to be obtained. The anticipated viewing distance is necessarily related to the physical size of the multi-layer product as is the size of the multi-layer product to the viewing distance. The optical effect, i.e., three dimensional effect, motion effect, flip image effect, is necessarily related to the physical size of the product, the number of linear aperture clear and opaque sections printed per inch of the optical effects layer pattern and the number of interlaced images printed per inch of the interlaced images layer, and the clear plastic space between the two elements, the optical effects layer and the interlaced images layer.

Multiple clear materials refers to the layers of clear material, such as PVC, making up the final laminate. In the case of a 30 mil credit card this would be comprised of a 26 mil clear core, a 2 mil clear top laminate, and a 2 mil bottom laminate. These clear PVC films are manufactured as gloss or matte surfaces or chemically frosted surfaces that can become clear after lamination. Other clear laminates can be added to create greater thickness for products not limited to credit cards. Conversely, thinner mil materials can be used to create thinner products including but not limited to credit cards.

The optical effects layer of the linear aperture clear and opaque sections consists of alternating clear and printed opaque sections. The width ratio of these clear spaces to opaque sections for current debit/credit cards are exemplified as within the range of from 4 to 1 to 6 to 1 but both this ratio and also the repetitive spaces per inch can vary based on the viewing distance, the clear space between the optical effects layer of the linear aperture surface and the corresponding interlaced images, and the number of interlacings.

A current optical effects layer of the linear aperture example above can consist of 75 alternating clear and opaque sections per linear inch as described above. The interlace images are the separator framed images printed on the opposing side of the clear material. Within 1/75^{th} of an inch, thin slivers of different graphic separator framed images are positioned adjacent to each other essentially by the use of a computer graphics program. The number of images can be as little as 2 or as many as can be reproduced within limits of the printing process being used. The number of images is based on the graphic effect required. For instance, if red is required to change to blue, only 2 images would repeat every 1/75^{th} inch. If a race car is required to move consisting of 8 motion frames, the frames would repeat themselves every eighth position, all 8 frames within the 1/75^{th} inch

The thickness of the material core layer and alignment of the separator framed images of the image layer with the aperture and opaque spaces of the aperture layer are elements of the computer graphics program.

A computer graphics program is an essential requirement for positioning the optical effects formation layer in alignment with the interlaced images and for positioning the slivers of different graphic images of the interlaced images layer. A suitable computer graphics program is Adobe™ Superflip™ or Adobe™ Photoshop™ available from Adobe Systems Incorporated, San Jose, Calif.

Offset lithography provides the optimum in detailed reproduction in that the registration of the different color print units is typically within 1/1000^{th} to 5/1000^{ths} of an inch. The offset lithography process can reproduce as little as a 10 micron spot. This allows for the interlacing in dimensions described above, 75 lines times 8 images being 600 images interlaced within 1 inch. In contrast, silk-screen printing would need a billboard to effectively achieve the same effect produced on a credit card of approximately three inches in length. Other forms of reproduction would have limitations in quality and cost effectiveness.

The structure described, the optical effects layer pattern of linear aperture clear and opaque sections and layer of interlaced images, can provide different images. A three-dimensional structure can describe an image that appears to have depth such as foreground and background. A motion structure can describe a racecar moving around a curve. Morphing images can change from one image to another as a cat changing to a dog. A flip image can be one that changes from red to blue or type that would change from “stop” to “go”.

While the procedure of placing the optical effects layer pattern of linear aperture clear space and opaque sections on one side and the layer of interlaced images on the opposing side of a clear material is known, the positioning and alignment of the optical effects layer pattern of linear aperture spaces and opaque sections in correspondence with interlaced separator framed images on an opposing surface of a clear material by use of a computer graphics program and hydraulically or adhesively laminating the optical effects layer pattern of the interlaced images into a fully protected unit has not been known in the prior art. The positioning and alignment procedure by use of a computer graphics program is an essential step in the preparation of the optical effects product to provide desired visual optical effects. The computer graphics program software facilitates the required input data to provide the operational printing specifications for the optical effects layer pattern of linear aperture clear spaces and opaque sections and the layer of interfaced images based on the input data or the viewing distance, physical size of the product, the optical effect required, the clear plastic space between the two layers, the number of linear aperture clear spaces and opaque sections in the optical effects layer, and the number of interfaced images of the interlaced images layer.

The above input data are determined experimentally by test runs.

An exemplified optical effects plastic multi-layer product comprising an exemplified credit card, conventionally 2.125×3.375 inches in size, and from 20 to 30 milliliters in thickness, conveniently has a ratio of relative spacing of the linear aperture clear spaces and opaque sections, which also serve as computer alignment marks, within the range of from four to one to six to one. The interlaced images based on the thickness of the exemplified card of from 20 to 30 milliliters can be in the range of from 74.5 to 75.5 images per inch.

For a 30 mil (standard credit card thickness) card, the invented process with hydraulic lamination would print on opposing sides of a 26 mil clear gloss or matte PVC. A hydraulic process would then spot attach a 2 mil clear matte material to front and back. If a magnetic stripe is required the process would first apply to the 2 mil back laminate. The 3 part unit is then placed between chrome finished polishing plates and placed into the hydraulic laminating press together with a number of like units and are processed under heat and pressure that fuses the three laminates together and converts all of the matte and chemically treated matte surfaces to clear and to form a solid unit sealing the ink under a 2 mil protective barrier. The conversion from multiple sheets by hydraulic lamination to a one piece see-through is a key factor since a totally clear laminated sheet is required to allow the linear aperture/interlaced images to become viewable. Adhesive lamination would require use of clear film. Thickness can vary based on the thickness of the core material and the thickness of the overlay films or with the addition of added lamination sheets. The thickness variability can be unique based on the application. Credit cards can range from 10 mil to 30 mil. Clipboard, rulers, calculators, etc, could reach 110 mil in thickness. While the credit card is the most likely application, the invented product and process are not excluded from other applications. Also unique is the fact that most lithographic presses limit their printable thickness to 24 mil, but this process allows lithographed material to be post-processed to greater thickness.

For the invented process with adhesive lamination for a 30 mil card, the invented adhesive lamination process would print on opposite sides of a 26 mil clear PVC plastic film. Other details of the process would be as for the hydraulic lamination process except that the three part unit is adhesively laminated together using suitable adhesive materials.

Currently available lenticular (pre-cast lens) cards must be pre-printed on the lens material then glued together with limited heat and pressure or the lens will be flattened causing distortion or total loss of the lens. The lower temperature used to adhere the laminates can cause separation of the laminates when stressed by pressure or exposed to heat as in a closed car exposed to sunlight. Also, lay flat is an important requirement for magnetic striped cards to work in swiping stations. The lenticular card typically has problems with bowing.

The optical effects aperture structure layer pattern of linear aperture structure and corresponding interlaced images of the instant invention can be overall or isolated to any shape, or area(s) of the card desired. Selected areas can remain stagnant. These stagnant areas can be clear, white or translucent, with or without images or graphics. Simply stated, stagnant refers to all areas not used in conjunction with a linear aperture structure layer and image layer. The actual printing of stagnant interlaced images and the optical effects layer pattern of linear aperture structure can be completed simultaneously from common printing plates with either the linear aperture structure and/or the interlaced images. The interlaced images can be positioned as to the top optical effects layer pattern of linear aperture structure surface and the opposing surface image layer since the material will become clear after hydraulic lamination.

Magnetic tapes can be applied to the 2 mil overlay PVC prior to collation of laminates. This results in the magnetic tape being compressed into the surface during the lamination process and resulting in what the card industry refers to as a flush mag. Other special effects such as foil stamping or silk screening can be applied to core material prior to collation of laminates. This results in those special effects becoming protected by the over-laminating PVC.

Hydraulic lamination is used in applications such as credit cards where PVC materials are fused under heat and pressure resulting in a very strong and durable rigid product manufactured to withstand heavy use. Features that result are images protected from scratching and wear, flexibility, impervious to moisture, lay-flatness, and longevity.

The invented method for preparing an optical effects layer structure of a linear aperture layer and an interlaced images layer hydraulic laminate product consists of

(a) preparing a single plastic layer structure object with clear overlaminate on clear or matte plastic on two exterior sides by:

(1) Lithographic printing upon a first side of a clear or matte plastic substrate using conventional offset lithographic printing to form an optical effects layer pattern comprising printed linear aperture clear and opaque sections consisting of multiple printed linear opaque sections separated by clear sections on first side of a transparent substrate surface wherein the aperture clear and opaque sections are in alignment by a computer graphics program with multiple interfaced separator framed images on a separate second side surface of said transparent substrate and specified clear and opaque sections per inch wherein width ratio of printed opaque sections to clear sections is only limited by the process.

(2) Lithographic printing upon the second side of said clear or matte plastic substrate having a printed optical effects layer of linear aperture clear and opaque sections on said first side to form a layer of interlaced separator framed images on said second side wherein width ratio of individual interlaced images to other individual interlaced images by a computer graphics program is in the range from 1 to 1000 to 1 to 2, to be in alignment with said ratio of said printed clear and opaque section of said first side wherein the said alignment between the printed optical effects layer of linear aperture clear and opaque spaces on the first side of the plastic substrate to said layer of printed interlaced separator framed images on the second side of the plastic substrate is controlled by a computer graphics program.

(3) Applying suitably-sized clear plastic overlaminating sheets of lesser or greater thickness of clear plastic substrate to said first and second sides to form a collated structure object.

(4) Laminating said collated structure object with polished plates at suitable temperature and pressure to form a laminated structure object.

(b) Preparing a multi-layered plastic structure object of greater thickness with clear overlaminate clear or matte plastic on two exterior sides by:

(1) Repeating the steps of (a) sub-paragraphs (1) and (2).

(2) Applying suitably-sized clear plastic sheets of at least equal or greater thickness of steps of (a) sub-paragraphs (1) and (2), to form a collated object.

(3) Repeating the steps of (a) sub-paragraphs (3) and (4) to form a laminated object of greater thickness than prepared by the process of (a).

(c) Preparing a multi-layered plastic structure object of greater thickness with clear overlaminate clear or matte plastic on two exterior sides by:

(1) Repeating the steps of (a) sub-paragraphs (1) and (2) but lithographic printing the indicia of said paragraphs on separate clear plastic substrates of polyvinyl chloride or other plastics of thickness at least equal or greater to that of the substrate of step (a).

(2) Collating and merging the two separate clear plastic substrates of (1) above in register to form a multiple layer plastic object of greater thickness than the object prepared by the process of (a), the said two sheets positioned in alignment with each other as the indicia of (a) sub-paragraph (2).

(d) The interlaced printed separator framed images are positioned as half or full portions of images to small portions of images such as slivers of images, said portions of different graphic images positioned adjacent to each other by use of a computer graphics program.

(e) The number of printed images can be as little as two and can be as many as can be reproduced within limits of the printing process being used.

As an example, a standard 30 mil CR80 credit card by hydraulic lamination is prepared as follows: A 26 mil clear or frosted PVC core stock is printed on both sides. The core stock is then spot tacked front and back with a 2 mil clear matte PVC and laminated together. If a magnetic stripe is required, it is applied to a roll of lamination film prior to collation. This 3 part set is placed between chrome laminating plates with similar collated sets, fused under heat and pressure and cooled. The fused and polished sheets are than processed through a Louda punching system using male and female dies and punched to a size of 3.375×2.1.125 inches. The invented method for preparing an optical effects layer pattern of linear aperture clear and opaque sections and another interlaced separator framed images layer by adhesive lamination consists of preparing a single plastic layer object with clear overlaminate plastics on two exterior sides and repeating the steps of (a) subparagraphs (1), (2) and (3) and laminating the collated object within a suitable adhesive to form a laminated object. The steps of (b), (c), (d) and (e) are repeated using clear plastic over-laminate.

In summary, the invention comprises a laminated visual optical effects structure plastic product and also comprises a process for producing a card with a multi-layered optical effects layer structure of linear aperture clear and opaque sections laminate having a core of clear material made up of one or multiple clear materials printed on opposing surfaces creating a visual optical effects layer structure of linear aperture clear and opaque sections on one side and an interlaced image(s) on the opposing side by using offset lithography, silk-screen, or other methods of producing reproduction products to create a durable, laminated, protected ultra-flat viewing graphic to provide special visual effects including but not limited to three-dimensional images, morphing images, and changeable images in the absence of a formed lens, the said process comprising the steps of printing upon a clear plastic substrate of polyvinyl chloride, or other plastic materials as listed above, on both sides of the plastic substrate, to form a structure comprising a plastic sheet with printed images on both sides in designated locations as per a computer graphics program, as follows:

a) printing on a first side of said plastic substrate an optical effects layer pattern of linear aperture having a clear and opaque section pattern or interference within the range of about 20 to 75 sections per inch and on the opposing side printed interlaced separator framed images wherein the printed images are printed as multiple images of alternating printed bands, each image, if more than one image is printed, being printed sequentially as a narrow band of image No. 1, followed by a narrow band of image No. 2, then followed by a narrow band of image No. 3, and continuing with narrow bands of images as required;

b) alternatively, interlaced image printing can be on a second separate plastic substrate apart from the first plastic substrate surface comprising the optical effects layer pattern of linear aperture clear and opaque sections wherein the interlaced separator framed image layer printing pattern matches the alignment of the optical effects pattern of linear aperture clear and opaque sections pattern layer and alignment of the optical effects pattern of linear aperture clear and opaque sections in sections per inch. Multiple images can be printed on the separate plastic substrate which are printed in alternating bands and lines to provide the overall graphic image as in step a);

c) aligning the graphic image layer as prepared in step c) to the optical interference linear aperture layer as an alternative to step b) to provide a viewing graphic comprised of a first plastic substrate, a second plastic substrate comprising an optical effects layer pattern of linear aperture layer screen within a range of 20 to 75 lines per inch, said interlaced images layer having printed images comprising multiple pictures printed in alternating bands and lines, and, alternatively, a third plastic substrate having printed images comprising multiple pictures printed in alternating bands and lines;

d) laminating the said viewing graphic with transparent plastic film which thermally bands the viewing graphic and serves to provide a durable, laminated, protected ultra-flat product. The lamination step can be by hydraulic lamination with heat and pressure or by adhesive lamination; and

e) after lamination, finishing the product by a variety of finishing methods including foil applications, holographic applications, signature panels, additional imaging, card punching, hollow-die die cutting, steel-rule die cutting, guillotine cutting, vacuum forming, and the like.

In the above-described process, the plastic materials can include polyvinylchloride, polyvinyl acetate, polyvinyl alcohol, polyester, polystyrene, polyethylene larephthalate, polystyrene, polyethylenes, polyethylene terephtalate glycol, and amorphous polyethylene terephtalate, and any suitable resin-based polymer.

What is claimed is:

1. A laminated multi-layered printed visual optical effects structure product as a viewing graphic comprising a core of plastic substrate film material printed on opposite opposing surfaces with a printed optical interference linear aperture clear and opaque sections layer on one surface of said film and a printed interlaced image layer on the opposing opposite surface of said substrate film surfaces positioned in alignment by means of a computer graphics program and wherein the optical interference linear aperture layer and the interlaced image layer are laminated over by an over-laminate layer of clear plastic film.

2. The visual optical effects structure product of claim 1 wherein the core of plastic film material is selected from clear plastic film, matte clear plastic film, laminate clear plastic film that can be laminated, and frosted film.

3. The visual optical effects structure product of claim 1 wherein said printed optical interference linear aperture layer on one surface comprises printed alternating clear and printed opaque sections wherein width ratio of clear and opaque sections is in the range of from 1 to 1000 to 1 to 2.

4. The visual optical effects structure product of claim 1 wherein said printed optical interference linear aperture layer consists of multiple alternating clear and opaque sections per inch.

5. The printed optical interference linear aperture layer of claim 4 wherein said layer consists of 20 to 75 alternating clear and opaque sections per inch.

6. The visual optical effects structure product of claim 1 wherein said printed interlaced image layer consist of thin slivers of different graphic images positioned adjacent to each other, the number of said image slivers based on the number of alternating clear and opaque sections per inch of said printed optical interference linear aperture layer sections per inch.

7. The positioned different graphic images adjacent to each other of claim 6 wherein said positioning is by means of a computer graphics program.

8. The number of said image slivers of claim 6 wherein number of different graphic images positioned adjacent to each other repeated per a number of 20 to 75 alternating clear and opaque sections per inch of said printed optical interference linear aperture layer is in the range of from 2 to 1000 per 1/75 of an inch.

9. The visual optical effects structure product of claim 1 wherein said printed visual optical effects is by offset lithography printing.

10. The visual optical effects structure product of claim 1 wherein said printed visual optical effects is by silk screen printing.

11. The visual optical effects structure product of claim 1 wherein said visual optical effects in the absence of a formed plastic lens include three-dimensional images, morphing images, motion images, flip images, and changeable images.

12. The positioned different graphic images adjacent to each other of claim 6 wherein said images form a printed images layer with images in designated locations of surface of said plastic film, more than one image being printed as a sequential narrow band of each image followed by sequential narrow bands of following images to provide graphic images for visual optical effects.

13. The positioned different graphic images of claim 12 wherein interlaced images of said printed images can be isolated to any designated location of surface of said plastic film and be congruent with said printed optical interference linear aperture layer designated as in alignment therewith.

14. The visual optical effects structure product of claim 1 wherein said printed optical interference linear aperture layer on one surface of said film are aligned with said printed interlaced image layer on opposing opposite surface of said film and said layers are positioned in alignment with each other to provide a visual viewing graphic provided by said printed images layer and said optical interference linear aperture layer.

15. The laminated multi-layered printed visual optical effects structure product of claim 1 wherein said core of plastic film material comprises a plastic film layer of from one plastic film to multiple plastic films layered together to form a composite film layer of multiple plastic films.

16. The laminated multi-layered printed visual optical effects structure product of claim 1 wherein said laminated product is prepared by hydraulically laminating said core of plastic film material with transparent over-laminating plastic film thermally bonded with heat and pressure to provide a durable, laminated protected product.

17. The hydraulically laminated multi-layered printed visual optical effects structure product of claim 16 wherein said heat and pressure thermally applied to said core of plastic film material converts frosted and matte film surfaced plastic material to see through totally clear laminated multi-layered printed optical effects product.

18. The laminated multi-layered printed visual optical effects structure product of claim 1 wherein said laminated product is prepared by adhesively laminating said core of plastic film material with transparent over-laminating plastic film to provide a durable, laminated protected product.

19. The laminated multi-layered printed visual optical effects structure product of claim 1 wherein said plastic film material is selected from the group consisting of polyvinylchloride, polyvinylacetate, polyvinylalcohol, polyesters, polyethylenes, polystyrene, polyethylene terephthalate, polyethylene terephthalate glycol, amorphous polyethylene terephthalate and any suitable resin-based polymer.

20. The laminated multi-layered printed visual optical effects structure product of claim 1 wherein said product of claim 1 comprises a single plastic substrate printed on both sides.

21. The laminated multi-layered printed visual optical effects layer of claim 1 wherein said product of claim 1 comprises a multi-layered plastic object of greater thickness than a single plastic substrate.

22. The visual optical effects structure product of claim 1 prepared by a process comprising the steps of:
(a) printing on a first side of a plastic substrate in designated locations a printed optical effects layer pattern of clear sections and printed opaque sections comprising linear aperture clear spaces and opaque sections having a printed pattern of interference width ratio within the range of from about 20 to 75 sections per inch and wherein width ratio of printed sections to clear spaces between printed sections is in the range of from 1 to 1000 to 1 to 2 per 1/75 of an inch, said designated locations and said printed line pattern controlled by a computer graphics program;
(b) printing on a second side of said plastic substrate printed interlaced images wherein said images are printed as a printed interlaced image layer of multiple interlaced images in designated locations wherein width ratio of interlaced images to other interlaced images is in the range of from 1 to 1000 to 1 to 2 per 1/75 of an inch and said interlaced images are in alignment with said width ratio of said printed line pattern of said first side of said plastic substrate wherein positioning and alignment between printed optical effects layer of linear aperture clear and opaque sections of said first side of said plastic substrate to said printed interlaced image layer of said second side of said plastic substrate is controlled by a computer graphics program;
(c) applying suitably sized plastic over-laminating sheets of plastic to first and second sides of said plastic substrate to form a collated object;
(d) laminating said plastic over-laminating sheets of plastic to said collated object.

23. The visual optical effects structure product of claim 1 wherein said plastic substrate film material comprises core plastic material of multiple plastic sheets.

24. The visual optical effects structure product of claim 1 wherein said viewing graphic on substrate film surfaces is positioned and aligned by a computer graphics program.
